(19) United States
(12) Patent Application Publication
(10) Pub. No.: US 2014/0222449 A1
(43) Pub. Date: Aug. 7, 2014

(54) GUARANTEED COST HEALTHCARE PRODUCTS, SYSTEMS, AND METHODS

(71) Applicant: AON GLOBAL RISK RESEARCH LIMITED, Hamilton (BM)

(72) Inventors: Timothy N. NIMMER, Castle Rock, CO (US); Justin M. KINDY, Greenwood Village, CO (US); Geoffrey KUHN, Chicago, IL (US)

(73) Assignee: AON GLOBAL RISK RESEARCH LIMITED, Hamilton (BM)

(21) Appl. No.: 14/171,534

(22) Filed: Feb. 3, 2014

Related U.S. Application Data
(60) Provisional application No. 61/759,918, filed on Feb. 1, 2013.

(51) Int. Cl. G06F 19/00

(52) U.S. Cl. CPC G06F 19/328
USPC 705/2

(57) ABSTRACT

Automated systems and methods for implementing and managing the submission, quote, proposal and binding stages (i.e., placement process) for securing insurance coverage.

### FIELD OF THE INVENTION

The present technology relates to insurance products, methods, and systems that can be offered to and used by employers who provide self-funded health care benefits to their employees.

### DESCRIPTION OF RELATED ART

Aggregate stop loss insurance is an insurance product that can currently be obtained by employers who offer self-funded employee benefits, and covers the employer for claims above a pre-defined monetary amount, which can be referred to as an attachment point. The attachment point is determined by the total amount of anticipated claims plus a margin, where the margin is a percentage of the total amount of anticipated claims. For example, if it is anticipated that an employer's employees will file one hundred million dollars in claims, the employer may be able to obtain aggregate stop loss insurance having an attachment point of one hundred fifteen million dollars, which is equal to the expected one hundred million dollars in claims plus a 15% margin. In such an example, the employer must pay for all claims up to a total of one hundred fifteen million dollars, and the insurance covers any claims above the attachment point threshold. Aggregate stop loss insurance products as currently known cover twelve months of incurred claims.

### BRIEF DESCRIPTION OF THE DRAWINGS

Specific examples have been chosen for purposes of illustration and description, and are shown in the accompanying drawings, forming a part of the specification.

FIG. 1 illustrates a high level diagram of the products, systems, and methods disclosed herein.

### DETAILED DESCRIPTION

Insurance products, methods, and systems of the present technology can be used as a replacement for traditional aggregate stop loss insurance.

Insurance products of the present technology include a guaranteed employer cost for a multi-year insurance term, a participation plan to be implemented by the participating employer, an insurance premium to be paid by the participating employer, and insurance coverage from an insurance or reinsurance provider that pays for any claims above the guaranteed employer cost. Some of the unique aspects of the insurance products of the present technology are the participation plan, the multi-year insurance term, and a significantly reduced margin for the attachment point of the insurance coverage as compared to aggregate stop loss insurance products. Typically, aggregate stop loss insurance products have a margin of at least about 15%, which is sometimes as high as 20% or 25%. In insurance products of the present technology the margin may be less than about 5%, may be within the range of 2% to 5%, may be about 1%, and may be less than 1%.

The participation plan is determined by the insurance product provider for each participating employer, and includes one or more program components, which can be selected from among the following categories of program components: plan design requirements, provider efficiency requirements, participant behavior requirements, high risk participant management requirements, and other health plan requirements. The components of the participation plan are selected based on an analysis of data provided by the participating employer, and are intended to decrease the costs of the participating employer's healthcare claims during the insurance term.

Plan design requirements are components relating to the healthcare plan that the participating employer offers to its employees. These components attempt to reduce claims costs by optimizing elements of the healthcare plan. One example of a plan design requirement is reducing the actuarial value of the plan, often with a focus on incenting specific behavior. As an example, participant copays or deductibles can be increased for emergency room visits but decreased for urgent care center visits in order to discourage unnecessary emergency room use. Another example of a plan design requirement is optimization of prescriptions by, for example, limiting the network, covering a closed formulary, or requiring clinical management for certain conditions. A third example of a plan design requirement is requiring full replacement of an employer's plan through a consumer driven health plan that increases consumerism by requiring each employee to have a deductible set at a high amount, relative to a deductible possible under the prior plan, and that incentivizes careful use of medical services. A fourth example of a plan design requirement is requiring the use of pricing tools in order to support transparency with respect to healthcare costs. These tools typically focus on helping plan members understand the cost differential between providers for similar services, allowing them to factor cost more directly into their health care purchasing decisions.

Provider efficiency requirements are components relating to the healthcare providers that can be used by participating employees. These components attempt to reduce claims costs by increasing the efficiency of the covered healthcare providers. One example of a provider efficiency requirement is network selection, which can be tailored to select network participants that provide care needed by the participating employees based on cost. Another example of a provider efficiency requirement is the implementation of reference-based pricing for standardized services. Use of reference-based pricing allows the consumers to select services at benchmark, pre-set prices. A third example of a provider efficiency requirement is requiring the use of a specialty center such as certain Centers Of Excellence (COEs), which can be either national or regional, for at least select complex procedures.

Participant behavior requirements are components relating to the behavior and practices of the participating employees. These components attempt to reduce claims costs by impacting risk migration within the participating employee population, by increasing the number of employees who have reduced risk over time, and/or by decreasing the number of employees who have increased risk over time. One example of a participant behavior requirement is the implementation of a wellness program, which can include targeted programs (e.g., nutritional, fitness, etc.) based on the risk profile of the participating employees as determined by the product provider through analysis of the employee medical information. Employees who do not participate in the wellness program may be required to pay more of the healthcare cost. For example, a participating employer may increase its base contribution towards the healthcare cost for employees that participate in the wellness program, or may decrease its base contribution towards the healthcare cost for employees that do not participate in the wellness program. Another example of a participant behavior requirement is the implementation of a rewards program that rewards verified health improvement without providing a specific wellness program.

High risk participant management requirements are components relating to the treatment and care of employee participants identified as being high risk, such as those with chronic conditions, multiple illnesses, or co-morbidities. One example of a high risk participant management requirement is a coordinated care program to ensure that high risk individuals are monitored.

The insurance term for health insurance products of the present technology is a multi-year term, meaning that the time period for which the insurance coverage is provided, and for which the employer cost is guaranteed, is greater than one year. For example, a multi-year insurance term can be for periods of two years or greater. In some examples, the insurance term may be two years, three years, four years, or five years. While the insurance term may be greater than five years, it is contemplated that insurance terms will preferably be between two years and five years. One reason for the use of a multi-year insurance term is to provide sufficient time to realize the intended cost reducing benefits of the participation plan. Another reason is to provide participating employers with the benefit of guaranteed costs for more than one fiscal year.

One method of providing a healthcare insurance product of the present technology can begin with a product provider offering a healthcare insurance product of the present technology to an employer, and the employer electing to accept the healthcare insurance product and thus become a participating employer.

The participating employer provides healthcare data to the product provider. The healthcare data may include, for example, anyone or more of the following information with respect to each employee of the participating employer:
Member-level eligibility
Consumer segmentation data
Medical/behavioral health claims
Prescription claims
Disease management, lifestyle management, case management, maternity management, complex behavioral health (BH), and care management/health advocacy programs
Health risk questionnaire responses
Biometric data

The product provider receives the healthcare data from the participating employer and analyzes it. The product provider and the participating employer negotiate, or otherwise determine, the employer cost that will be the guaranteed employer cost for the insurance term. The product provider also determines the program components that will be implemented in the participation plan for the participating employer.

Once the components of the participation plan have been determined, the product provider acts as a broker and engages an insurance or reinsurance provider to pay for any claims above the guaranteed employer cost, plus any margin that may be included, in exchange for an insurance premium. The product provider then provides the insurance product to the participating employer. As discussed above, the insurance product includes a guaranteed employer cost for the multi-year insurance term, the participation plan to be implemented by the participating employer, and an insurance premium to be paid by the participating employer. The participating employer then implements the participation plan, pays an insurance premium, and receives insurance coverage for the insurance term. The insurance premium may be paid by the employer to the product provider, who would then provide it to the insurer, or may be paid directly from the employer to the insurer.

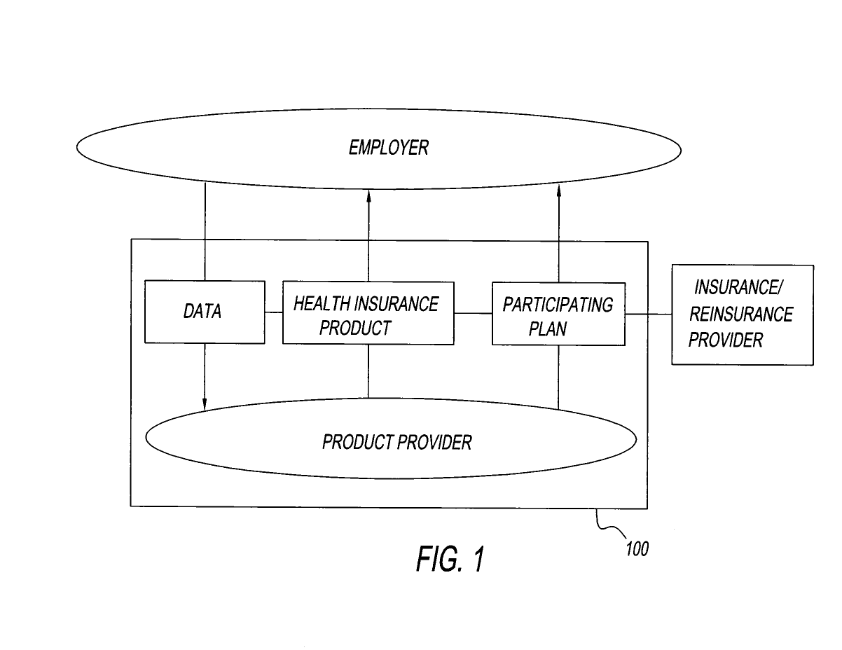

Systems of the present technology can include one or more computing devices, which can be in communication with one another through any wireless or wired communication medium, such as the Internet. Systems of the present technology can also include one or more programs, such as software programs, stored on at least one non-transitory computer readable medium, such as a hard drive, disk, or flash drive, that can be executed by the one or more computing devices in order to carry out the methods described above for providing a healthcare insurance product of the present technology. For example, FIG. 1 depicts a computing device 100 used by a healthcare insurance product provider to offer an employer a healthcare insurance product; to receive input data from the employer related to healthcare information of the employees of the employer; to analyze the input data to determine a possible program component of a participation plan; to determine the cost to be covered by the employer as the guaranteed employer cost; to engage a provider to pay for any claims above the guaranteed employer cost; to generate an electronic submission proposal regarding the participation plan; and to deliver the electronic submission proposal to the employer.

Health insurance products, methods, and systems of the present technology can include adjustments to the employer cost during the insurance term.

In one example, the employer cost can be linked to the S&P healthcare cost index. In such an example, the employer cost could be a flat guaranteed amount for each year of the insurance term in which the S&P healthcare cost index is below a certain percentage, such as, for example, 8%, 10%, or 5%. For any year during the insurance term where the S&P healthcare cost index exceeds the certain percentage, the employer cost may be incrementally increased.

In another example, the employer cost may be adjusted on a per employee per year basis. Thus, the employer cost may be adjusted due to changes in the employee population enrolled in the program, with respect to any relevant factor, including but not limited to the number of participating employees, and/or the health risks associated to the participating employee population.

In another example, a stabilization fund can be included. The stabilization fund is a fund that can be created to receive payments from or provide payments to a participating employer to account for performance of the participation plan and balance out the employer cost during the multi-year term. Because the employer cost is guaranteed for a multi-year insurance term, the cost for each individual year has the potential to vary, based on variance in the amount of claims filed from year to year during the multi-year term. In one example of an insurance product of the present technology that does not use a stabilization fund, the employer would pay for all claims over the multi-year term, and would be reimbursed at the end of the multi-year term for any claims above the attachment point. In another example of an insurance product of the present technology that does not use a stabilization fund, the employer would pay for all claims during multi-year term up to the attachment point, and then the insurer would pay for any additional claims. However, in an example of an insurance product of the present technology that does use a stabilization fund, the employer can receive payments from, or make payments into, the stabilization fund to ensure that the employer cost is equal for each year of the multi-year term. Thus, for example, if the employer cost for a three year term is guaranteed to be three hundred million dollars, and the margin is 0%, the stabilization fund can be used to ensure that the employer cost in each of the three years is equal to one third of the total employer cost, or one hundred million dollars. If the total claims in the first year are one hundred ten million, the employer would receive a payment of ten million dollars from the stabilization fund at the end of the first year. If the total claims in the second year are only ninety million dollars, then the employer would pay ten million into the stabilization fund. Finally, if the total claims in the third year are one hundred fifteen million dollars, then the employer would receive a payment of fifteen million from the stabilization fund at the end of the third year.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A method of providing a healthcare insurance product, said method comprising steps of:
offering a healthcare insurance product to an employer from a healthcare insurance product provider;
receiving input data from the employer via a computing device by the healthcare insurance product provider;
analyzing the input data on the computing device to determine a possible program component of a participation plan;
determining the cost to be covered by the employer as the guaranteed employer cost, wherein the participation plan has a term that extends at least two years;
engaging a provider to pay for any claims above the guaranteed employer cost;
generating, at the computing device, an electronic submission proposal regarding the participation plan; and
delivering, from the computing device, the electronic submission proposal to the employer.

2. The method of claim 1, wherein the input data is at least one of member-level eligibility, consumer segmentation data, medical/behavioral health claims, prescription claims, disease management, lifestyle management, case management, maternity management, complex behavioral health and care management/health advocacy programs, health risk questionnaire responses, and biometric data.

3. The method of claim 1, wherein the program component of the participation plan is at least one of a plan design requirement, a provider efficiency requirement, a participant behavior requirement, and a high risk participant management requirement.

4. The method of claim 3, wherein the plan design requirements is at least one of reducing the actuarial value of the plan by incenting specific behavior.

5. The method of claim 4, wherein the specific behavior incented involves setting copays or deductibles for the participant to discourage a visit to an emergency room relative to a visit to an urgent care center.

6. The method of claim 4, wherein the specific behavior incented involves optimization of prescriptions by at least one of limiting the network, covering a closed formulary, and requiring clinical management for certain conditions.

7. The method of claim 4, wherein the specific behavior incented involves requiring each employee to have a deductible set at a relatively high amount.

8. The method of claim 4, wherein the specific behavior incented involves helping plan members to understand the cost differential between providers for similar services.

9. The method of claim 3, wherein the provider efficiency requirement is achieved by at least one of selecting network participants that provide care needed by the participating employees based on cost, implementing reference-based pricing for standardized services, and requiring the use of a specialty center for at least select complex procedures.

10. The method of claim 3, wherein the participant behavior requirement is achieved by at least one of implementing a wellness program and implementing a rewards program that rewards verified health improvement without providing a specific wellness program.

11. The method of claim 3, wherein the high risk participant management requirement is achieved by a coordinated care program to ensure that high risk individuals are monitored.

12. The method of claim 1, further comprising receiving an acceptance from the employer, at the computing device, by the healthcare insurance product provider regarding the electronic submission proposal to bind the healthcare insurance product provider and the employer.

13. The method of claim 12, further comprising adjusting the guaranteed employer cost during the term.

14. The method of claim 13, wherein the guaranteed employer cost is linked to the S&P healthcare cost index and the guaranteed employer cost is a flat guaranteed amount for each year of the term in which the S&P healthcare cost index is below a certain percentage, and wherein, for any year during the term where the S&P healthcare cost index exceeds the certain percentage, the employer cost may be incrementally increased.

15. The method of claim 13, wherein the guaranteed employer cost is adjusted due to changes in the employee population enrolled in the participation plan.

16. The method of claim 13, further comprising use of a stabilization fund to receive payments or to provide payments to the employer to account for performance of the participation plan and balance out the guaranteed employer cost during the term.

17. A method of providing a healthcare insurance product, said method comprising steps of:
offering a healthcare insurance product to an employer from a healthcare insurance product provider;
receiving input data from the employer via a computing device by the healthcare insurance product provider;
analyzing the input data on the computing device to determine a possible program component of a participation plan,
wherein the program component of the participation plan is at least one of a plan design requirement, a provider efficiency requirement, a participant behavior requirement, and a high risk participant management requirement;
determining the cost to be covered by the employer as the guaranteed employer cost, wherein the participation plan has a term that extends at least two years;
engaging a provider to pay for any claims above the guaranteed employer cost;
generating, at the computing device, an electronic submission proposal regarding the participation plan;
delivering, from the computing device, the electronic submission proposal to the employer; and
receiving an acceptance from the employer, at the computing device, by the healthcare insurance product provider regarding the electronic submission proposal to bind the healthcare insurance product provider and the employer.

18. The method of claim 17, wherein the input data is at least one of member-level eligibility, consumer segmentation data, medical/behavioral health claims, prescription claims, disease management, lifestyle management, case management, maternity management, complex behavioral health and care management/health advocacy programs, health risk questionnaire responses, and biometric data.

19. The method of claim 17, wherein the plan design requirements is at least one of reducing the actuarial value of the plan by incenting specific behavior.

20. The method of claim 19, wherein the specific behavior incented involves setting copays or deductibles for the participant to discourage a visit to an emergency room relative to a visit to an urgent care center.

21. The method of claim 19, wherein the specific behavior incented involves optimization of prescriptions by at least one of limiting the network, covering a closed formulary, and requiring clinical management for certain conditions.

22. The method of claim 19, wherein the specific behavior incented involves requiring each employee to have a deductible set at a relatively high amount.

23. The method of claim 19, wherein the specific behavior incented involves helping plan members to understand the cost differential between providers for similar services.

24. The method of claim 17, wherein the provider efficiency requirement is achieved by at least one of selecting network participants that provide care needed by the participating employees based on cost, implementing reference-based pricing for standardized services, and requiring the use of a specialty center for at least select complex procedures.

25. The method of claim 17, wherein the participant behavior requirement is achieved by at least one of implementing a wellness program and implementing a rewards program that rewards verified health improvement without providing a specific wellness program.

26. The method of claim 17, wherein the high risk participant management requirement is achieved by a coordinated care program to ensure that high risk individuals are monitored.

27. A method of providing a healthcare insurance product, said method comprising steps of:
offering a healthcare insurance product to an employer from a healthcare insurance product provider;
receiving input data from the employer via a computing device by the healthcare insurance product provider;
wherein the input data is at least one of member-level eligibility, consumer segmentation data, medical/behavioral health claims, prescription claims, disease management, lifestyle management, case management, maternity management, complex behavioral health and care management/health advocacy programs, health risk questionnaire responses, and biometric data;
analyzing the input data on the computing device to determine a possible program component of a participation plan,
wherein the program component of the participation plan is at least one of a plan design requirement, a provider efficiency requirement, a participant behavior requirement, and a high risk participant management requirement;
determining the cost to be covered by the employer as the guaranteed employer cost, wherein the participation plan has a term that extends at least two years;
engaging a provider to pay for any claims above the guaranteed employer cost;
generating, at the computing device, an electronic submission proposal regarding the healthcare insurance product and the participation plan;
delivering, from the computing device, the electronic submission proposal to the employer; and
receiving an acceptance from the employer, at the computing device, by the healthcare insurance product provider regarding the electronic submission proposal to bind the healthcare insurance product provider and the employer.
